(19) United States
(12) Patent Application Publication
(10) Pub. No.: US 2024/0316650 A1
(43) Pub. Date: Sep. 26, 2024

(54) TOOL

(71) Applicant: MAPAL FABRIK FÜR PRÄZISIONSWERKZEUGE DR. KRESS KG, Aalen (DE)

(72) Inventors: Thomas FEILE, Ellwangen (DE); Alexander SUCHANOW, Bopfingen (DE); Martin CZAPKA, Ellwangen (DE)

(73) Assignee: MAPAL FABRIK FÜR PRÄZISIONSWERKZEUGE DR. KRESS KG, Aalen (DE)

(21) Appl. No.: 18/579,059

(22) PCT Filed: Jul. 18, 2022
(86) PCT No.: PCT/EP2022/070080

§ 371 Date: Jan. 12, 2024

(30) Foreign Application Priority Data
Jul. 20, 2021 (DE) 10 2021 207 764.1

(51) Int. Cl. B23B 5/12

(52) U.S. Cl. CPC B23B 5/12; B23B 2220/40; B23B 2222/04; B23B 2222/84; B23B 2270/30; B23B 2270/34

(57) ABSTRACT

A tool for machining an outer circumferential surface of a workpiece, with an interface adapted for fastening the tool to a counter interface, and a base body which is cylindrical at least in sections. The base body has a circumferential wall encompassing a mounting space and is configured to be open at the frontal side in such a way that the workpiece can be at least partially accommodated in the mounting space. At least one cutting edge engaging in the mounting space is arranged on the base body for the machining of the outer circumferential surface of the workpiece. The circumferential wall has at least one chip passing recess which is arranged relative to the at least one cutting edge in such a way that chips removed by the at least one cutting edge during the machining of the workpiece can exit through the at least one chip passing recess from the mounting space into an outer surrounding area of the base body.

The invention relates to a tool for machining an outer circumferential surface of a workpiece.

Workpieces which have a large outer diameter, in particular of more than 170 mm, with a simultaneously large projection length, in particular of at least 0.8 times the outer diameter, are typically machined by turning, in particular on turn-mill centres. This is particularly disadvantageous with regard to an overall manufacturing strategy for the production of complex components, in particular stator housings for electric motors, as a large amount of time and money is required, in particular with regard to the use of different machining stations and the reclamping of different tools, in particular those required for internal machining on the one hand and external machining on the other. In particular, the inner diameters of such workpieces can typically be machined with rotating tools on a machining centre, which allows fast and, in particular, automated reclamping. It would therefore be desirable to also be able to machine the outer diameters of such workpieces, i.e. the outer circumferential surfaces, with a rotating tool on a machining centre. However, the machining of outer circumferential surfaces on machining centres is currently only possible with so-called bridge tools, which carry cutting edges on arms projecting radially from an interface, wherein only comparatively small projection lengths and/or outer diameters can be machined for geometric and stability reasons. The problem outlined here arises in particular for fine machining (IT7 quality) of correspondingly large outside diameters, especially with large projection lengths.

The invention is based on the problem to provide a tool for machining an outer circumferential surface of a workpiece, wherein the disadvantages mentioned are at least reduced, preferably avoided.

The problem is solved by providing the present technical teaching, in particular the teaching of the independent claims and the embodiments disclosed in the dependent claims and the description.

In particular, the problem is solved by providing a tool for machining an outer circumferential surface of a workpiece comprising an interface adapted for attaching the tool to a counter interface. The tool also has a base body which is cylindrical at least in sections. The base body has a circumferential wall comprising a mounting space and is configured to be open at the frontal end so that the workpiece can be at least partially accommodated in the mounting space. At least one cutting edge engaging in the mounting space for machining the outer circumferential surface of the workpiece is arranged on the base body. The circumferential wall has at least one chip passing recess, which is arranged relative to the at least one cutting edge in such a way that chips removed by the at least one cutting edge during machining of the workpiece can exit through the at least one chip passing recess from the mounting space into an outer surrounding area of the base body. The base body, which is cylindrical in at least some sections, gives the tool a high degree of stability so that large outer diameters can be machined with high quality, even with large projection lengths, and in particular also finely machined (at least IT7 quality and better). During machining, the machined workpiece can be held in the mounting space, which is open at the frontal end, wherein the tool grips the workpiece with the circumferential wall at least in certain areas. The tool is thus configured in particular as a tubular or bell-shaped tool, which provides intrinsically high stability. The outer circumferential surface of the workpiece, i.e. the outer diameter, can be machined with the at least one cutting edge engaging in the mounting space, i.e. projecting in particular in a radial direction into the mounting space. The chips produced in the process can exit radially outwards through the chip passing recess associated with the cutting edge, so that damage to the workpiece surface by chips arranged, in particular trapped, between the outer circumferential surface of the workpiece and the circumferential wall of the tool, in particular the outer circumferential surface of the workpiece, is effectively prevented. This, together with the high stability of the tool, ensures a very high machining quality. In addition, the chip passing recess favourably reduces the weight of the tool, which has a positive effect on the machining accuracy with large projection lengths. Finally, the interface makes it possible to advantageously connect the tool to a counter interface, in particular a machine spindle, especially preferably of a machining centre, wherein it is possible in particular to perform rotary machining of the workpiece in such a way that either the tool or the workpiece is rotated about an imaginary longitudinal axis of the tool, or that both the tool and the workpiece are rotated relative to each other about the longitudinal axis of the tool. This in turn advantageously allows at least the essential machining steps of the workpiece, in particular both internal machining and external machining, to be carried out at the same machining station, in particular a machining centre, which significantly reduces the time and costs associated with machining the workpiece. In particular, set-up and reclamping times are significantly reduced.

In particular, the tool proposed here allows complete machining of a pot-shaped stator housing for an electric motor on a single machine, in particular a machining centre. Both the inner diameter, i.e. an inner circumferential surface, and the outer diameter, i.e. the outer circumferential surface, of the pot-shaped stator housing can be machined on the same machine, in particular the machining centre.

In a preferred embodiment of the tool, the interface is configured as a hollow shank taper interface, a steep taper interface, a Morse taper interface or in another suitable manner.

In the context of the present technical teaching, an axial direction or longitudinal direction is understood in particular as a direction that extends along a longest extension, preferably along an axis of symmetry or rotation of the preferably cylindrically symmetrical, in particular rotationally symmetrical tool. A radial direction is perpendicular to the axial direction. A circumferential direction surrounds the axial direction concentrically.

In a preferred embodiment, the tool comprises exactly one cutting edge. In another preferred embodiment, the tool comprises a plurality of cutting edges.

In a preferred embodiment, the tool comprises exactly one chip passing recess. In another preferred embodiment, the tool comprises a plurality of chip passing recesses.

In a preferred embodiment of the tool, the base body is configured to be circularly cylindrical or rotationally symmetrical.

In a preferred embodiment of the tool, the base body is configured in a tubular shape.

In a preferred embodiment of the tool, the at least one cutting edge is arranged on the circumferential wall of the base body.

In particular, the at least one cutting edge has a geometrically defined or geometrically determined cutting rim.

In a preferred embodiment of the tool, the at least one cutting edge is configured as a knife plate, cutting insert or indexable insert comprising at least one geometrically defined or geometrically determined cutting rim.

In particular, the at least one cutting edge is in machining engagement with the outer circumferential surface of the workpiece when the workpiece is at least partially received in the mounting space.

According to a further development of the invention, it is provided that the tool has a plurality of cutting edges as the at least one cutting edge, wherein the circumferential wall has a plurality of chip passing recesses, and wherein at least one cutting edge of the plurality of cutting edges is associated with each chip passing recess of the plurality of chip passing recesses in such a way that chips removed by the respectively associated cutting edge can exit through the associated chip passing recess from the mounting space into the outer surrounding area. It is possible that each chip passing recess of the plurality of chip passing recesses is assigned exactly one cutting edge of the plurality of cutting edges. However, it is also possible that a plurality of cutting edges, in particular at least two cutting edges, is assigned to at least one chip passing recess of the plurality of chip passing recesses. Preferably, however, each cutting edge of the plurality of cutting edges is assigned one—in particular exactly one—chip passing recess, so that for each cutting edge of the plurality of cutting edges, the chips removed by the respective cutting edge can exit through the assigned chip passing recess in a radial direction into the outer surrounding area. If the tool comprises a plurality of chip passing recesses, this also advantageously reduces the weight of the tool, which also takes into account the lightweight construction concept.

According to a further development of the invention, it is provided that the at least one chip passing recess is configured to be closed along a closed recess circumferential line. The recess circumferential line extends around a radius vector which is perpendicular to the axial direction of the tool and penetrates the chip passing recess. The recess circumferential line is therefore a line that encompasses the circumference of the chip passing recess and not a line that encompasses the circumference of the tool. The term “circumference” here therefore refers to the circumference of the chip passing recess and not to the circumference of the tool. In this case, the at least one chip passing recess is configured in particular as a window in the circumferential wall. In particular, the chip passing recess is in particular completely framed by the material of the circumferential wall and/or by material of another tool part, for example a frontal cutting ring. In this way, the stability of the base body in particular and thus also of the tool as a whole is high.

According to a further development of the invention, it is provided that the circumferential wall has at least one additional recess. The at least one additional recess advantageously contributes to a further reduction in the weight of the tool, so that it can be configured to be particularly light. This particularly takes into account the lightweight construction concept.

In particular, no cutting edge is assigned to the additional recess—in contrast to a chip passing recess. The additional recess is therefore particularly free of a cutting edge. In particular, the additional recess is not used for the passage of chips.

According to a further development of the invention, it is provided that the at least one additional recess extends through the circumferential wall. In particular, the mounting space is open to the outer surrounding area in the region of the additional recess. This design results in a considerable weight reduction for the tool.

Alternatively, it is preferable for the at least one additional recess to be closed—in the radial direction—at least one sided. The additional recess is preferably closed towards the mounting space, or towards the outer surrounding area of the tool, or on both sides. An additional recess that is closed on both sides can be produced in particular by means of a generative or additive manufacturing process.

In an embodiment, the circumferential wall is thinned out in the area of the additional recess, i.e. its wall thickness is reduced. However, the circumferential wall still has a finite wall thickness in the area of the additional recess. In particular, the additional recess is configured as a pocket in the circumferential wall. In particular, the additional recess thus has a base which separates a volume of the additional recess from the mounting space or from the outer surrounding area. The at least one additional recess that is closed towards the mounting space also leads to a considerable weight reduction for the tool, wherein the tool simultaneously has a significantly greater stability than if the additional recess extends through the circumferential wall.

In a preferred embodiment of the tool, the circumferential wall has at least one additional recess that extends through the circumferential wall and at least one additional recess that is closed on at least one sided. The various embodiments of the additional recess can therefore also be advantageously combined with one another, in particular in order to simultaneously reduce the weight of the tool and increase its stability.

According to a further development of the invention, it is provided that the at least one cutting edge is arranged on a flight circle with a diameter of at least 170 mm to at most 300 mm, preferably from at least 180 mm to at most 280 mm, preferably from at least 190 mm to at most 270 mm, preferably from at least 200 mm to at most 260 mm. Thus, the tool is advantageously adapted in particular to machine workpieces with a large outer diameter.

According to a further development of the invention, it is provided that the mounting space has a length from an opening sided end face to a base face—opposite the opening sided end face in axial direction—which corresponds to the flight circle multiplied by a factor of at least 0.8 to at most 3.5, preferably from at least 2 to at most 3, preferably from at least 1.5 to at most 2.5. The tool is thus adapted in particular to machine workpieces with a large projection length. In particular, the opening sided end face is arranged opposite the interface in the axial direction. The mounting space is open in the area of the end face so that the workpiece can be inserted into the mounting space from the opening sided end face. In particular, the opening sided end face surrounds an opening in the mounting space through which the workpiece can be inserted into the mounting space. The base face is arranged in the longitudinal direction on the side of the interface. Preferably, the interface is configured integrally with the base face or is connected in multipart form.

According to a further development of the invention, it is provided that the tool comprises as the at least one cutting edge at least one first cutting edge and at least one second cutting edge, wherein the at least one first cutting edge is arranged offset relative to the at least one second cutting edge in the axial direction of the base body. In addition, the at least one first cutting edge is assigned a first flight circle, which is different from a second flight circle assigned to the at least one second cutting edge. The at least one first cutting edge and the at least one second cutting edge are thus offset not only axially, but also radially in relation to one another. This advantageously allows a stepped external machining of the workpiece, in particular the simultaneous or sequential machining of a plurality of different external diameters on the same workpiece.

According to a further development of the invention, it is provided that the base body and the interface are configured in multipart form and are connected to one another. This advantageously enables the interface in particular to be manufactured separately from the base body, in particular from a different material. This in turn allows a higher degree of rigidity and/or stability to be provided for the interface in particular than for the base body, which is advantageous as greater forces are typically applied in the area of the interface; at the same time, the base body can be configured to be lightweight yet stable.

In a preferred embodiment of the tool, it is provided that the interface is connected to the base body, in particular to the base face, in a form-fit, friction-fit and/or material-fit manner. Preferably, the interface is screwed to the base body, in particular to the base face.

In an alternative preferred embodiment of the tool, the interface is configured integrally, preferably in the same material, with the base body. This allows the tool to be manufactured in a particularly cost-effective and simple manner.

According to a further embodiment of the invention, it is provided that the base body comprises a first material, wherein the interface comprises a second material. In particular, the first material is a different material than the second material. In particular, the base body and the interface thus comprise different materials or consist of different materials. This advantageously allows the choice of material to be optimised for the interface on the one hand and for the base body on the other with regard to the various desired properties. In particular, increased rigidity and/or stability can be provided for the interface, wherein the base body can be configured to be light and stable at the same time.

In a preferred embodiment of the tool, the first material has a lower density than the second material. This means that the base body can be configured to be particularly light. At the same time, the interface can be configured to be particularly rigid and/or stable.

In a preferred embodiment of the tool, the first material is a light metal and the second material is steel. Preferably, the first material is aluminium or an aluminium alloy. The corresponding choice of material enables a rigid and/or stable design of the interface with a simultaneously light and stable design of the base body.

According to a further development of the invention, it is provided that a cutting edge ring comprising at least one end cutting edge is arranged on the opening sided end face of the base body. By means of the at least one end cutting edge, an end face of the workpiece, i.e. in particular a surface on which the axial direction is perpendicular, can be advantageously machined in addition to the outer circumferential surface.

In a preferred embodiment, the cutting ring comprises exactly one end cutting edge. In another preferred embodiment, the cutting ring has a plurality of end cutting edges. Preferably, the cutting ring comprises as the at least one end cutting edge at least one first end cutting edge and at least one second end cutting edge, wherein the at least one first end cutting edge is arranged radially offset on the cutting ring relative to the at least one second end cutting edge.

In particular, the at least one end cutting edge has a geometrically defined or geometrically determined cutting rim.

In a preferred embodiment of the tool, the at least one end cutting edge is configured as a knife plate, cutting plate or indexable insert comprising at least one geometrically defined or geometrically determined cutting rim.

In a preferred embodiment of the tool, the cutting ring is configured in multipart form with the base body and is connected to the base body. In this way, the choice of material for the cutting ring on the one hand and the base body on the other can be advantageously optimised with regard to the properties required in each case.

In a preferred embodiment of the tool, the cutting ring has a third material comprising a higher density than the first material of the base body. This means that the cutting ring can be advantageously configured to be more stable and/or stiffer than the base body. Preferably, the cutting ring also advantageously contributes to the overall stability of the tool. Preferably, the third material is the same material as the second material of the interface.

In a preferred embodiment of the tool, the third material is steel.

In a preferred embodiment of the tool, the cutting ring has at least one chip removal groove assigned to the at least one end cutting edge, which is arranged and configured in such a way that chips removed by the at least one end cutting edge can be removed via the chip removal groove assigned to the end cutting edge, in particular in the radial direction—and/or in the axial direction in the direction of the interface. Preferably, each end cutting edge of a plurality of end cutting edges of the cutting ring is assigned a—in particular separate—chip removal groove.

According to a further development of the invention, it is provided that the at least one cutting edge is configured integrally with the circumferential wall. Preferably, the at least one cutting edge is machined out of the circumferential wall. Preferably, the cutting edge, in particular the cutting rim of the cutting edge, is coated with a hard material.

In an alternative embodiment of the tool, it is provided that the at least one cutting edge is material-fit to the circumferential wall. Preferably, the at least one cutting edge is bonded, welded or soldered to the circumferential wall.

In an alternative embodiment of the tool, it is provided that the at least one cutting edge is attached to the circumferential wall in a form-fit and/or friction-fit manner. Preferably, the at least one cutting edge is screwed to the circumferential wall.

Alternatively or additionally, it is preferable that the at least one cutting edge is arranged adjustable on the circumferential wall. In this way, in particular an axial and/or radial position of the at least one cutting edge can be advantageously set, in particular finely adjusted. In this way, a machining diameter, i.e. in particular a flight circle, of the at least one cutting edge can be adjusted with high precision.

In a preferred embodiment of the tool, it is provided that the at least one cutting edge is accommodated in a cutting edge cassette, wherein the cutting edge cassette is arranged, in particular fastened, preferably screwed, to the circumferential wall. The cutting edge can be connected to the cutting edge cassette in a material-fit manner, in particular bonded, soldered and/or welded, or connected in a form-fit and/or friction-fit manner, in particular screwed. In a preferred embodiment, an adjustment mechanism of the tool, which is adapted to adjust an axial and/or radial position of the cutting edge, can either be provided on the cutting edge cassette, or it can be provided on the circumferential wall and adapted to act on the cutting edge cassette and thus adjust the cutting edge indirectly via an adjustment of the cutting edge cassette.

In an embodiment of the tool, it is provided that the at least one end cutting edge is configured integrally with the cutting ring. Preferably, the at least one end cutting edge is machined out of the cutting ring. Preferably, the end cutting edge, in particular the cutting rim of the end cutting edge, is coated with a hard material.

In an alternative embodiment of the tool, it is provided that the at least one end cutting edge is material-fit to the cutting ring. Preferably, the at least one end cutting edge is bonded, welded or soldered to the cutting ring.

In an alternative embodiment of the tool, it is provided that the at least one end cutting edge is attached to the cutting ring in a form-fit and/or friction-fit manner. Preferably, the at least one end cutting edge is screwed to the cutting ring.

Alternatively or additionally, it is preferably provided that the at least one end cutting edge is arranged adjustable on the cutting ring. In this way, in particular an axial and/or radial position of the at least one end cutting edge can be advantageously set, in particular finely adjusted. In this way, a machining diameter, i.e. in particular a flight circle, of the at least one end cutting edge can be adjusted with high precision.

In a preferred embodiment of the tool, it is provided that the at least one end cutting edge is accommodated in a cutting edge cassette, wherein the cutting edge cassette is arranged, in particular fastened, preferably screwed, to the cutting ring. The end cutting edge can be connected to the cutting edge cassette in a material-fit manner, in particular bonded, soldered or welded, or connected in a form-fit and/or friction-fit manner, in particular screwed. In a preferred embodiment, an end adjustment mechanism of the tool, which is adapted to adjust an axial and/or radial position of the end cutting edge, can either be provided on the cutting edge cassette, or it can be provided on the cutting edge ring and adapted to act on the cutting edge cassette and thus adjust the end cutting edge indirectly by adjusting the cutting edge cassette.

According to a further development of the invention, it is provided that at least one guiding bar engaging in the mounting space is arranged on the base body. In this way, the tool is advantageously adapted for fine machining of the outer circumferential surface of the workpiece, in particular for finishing. If, on the other hand, the tool does not comprise such a guiding bar, it can be adapted in particular for pre-machining the outer circumferential surface of the workpiece.

According to a further development of the invention, it is provided that the circumferential wall, including the at least one chip passing recess, comprises a plurality of recesses, wherein each recess of the plurality of recesses is selected from a group consisting of a chip passing recess and an additional recess. This allows the base body to be configured in a particularly lightweight manner. The at least one chip passing recess is therefore in particular one of the recesses.

In an embodiment of the tool, the plurality of recesses is arranged in such a way that material of the circumferential wall is not recessed in areas of load paths occurring during the machining of a workpiece. In particular, the plurality of recesses is preferably arranged in such a way that material of the circumferential wall is not recessed exclusively where load paths occur during the machining of a workpiece. In particular, the recesses, especially the chip passing recesses and the additional recesses, are framed by webs or struts forming the circumferential wall, which extend along the load paths. In particular, the base body is configured in a quasi lattice-like manner. The tool thus advantageously—in the sense of the lightweight construction concept—comprises a very high stability with an extremely low weight.

The invention is explained in more detail below with reference to the drawing. It shows:

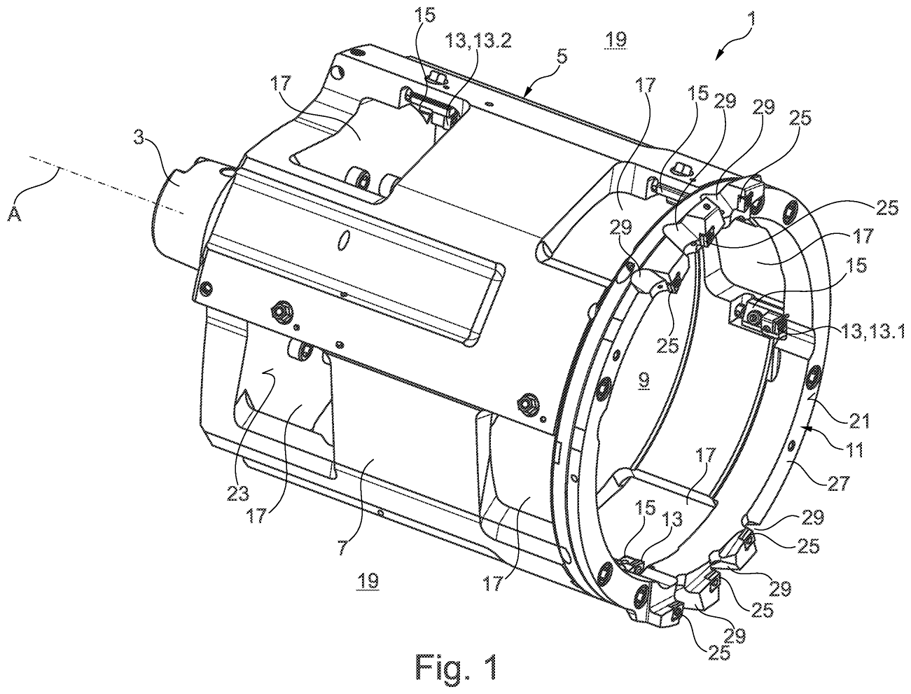

FIG. 1 a first illustration of a first embodiment of a tool;

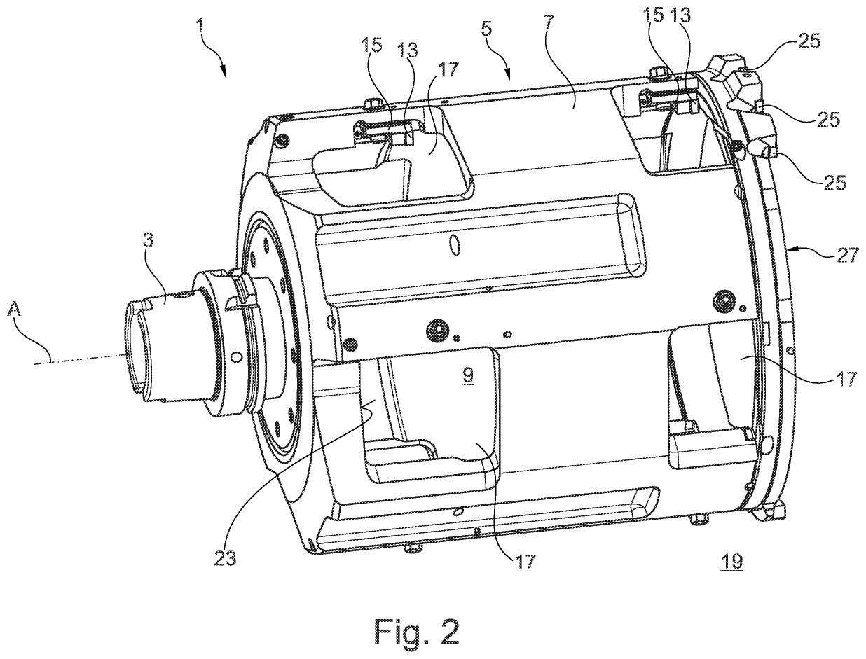

FIG. 2 a second illustration of the first embodiment of the tool according to FIG. 1;

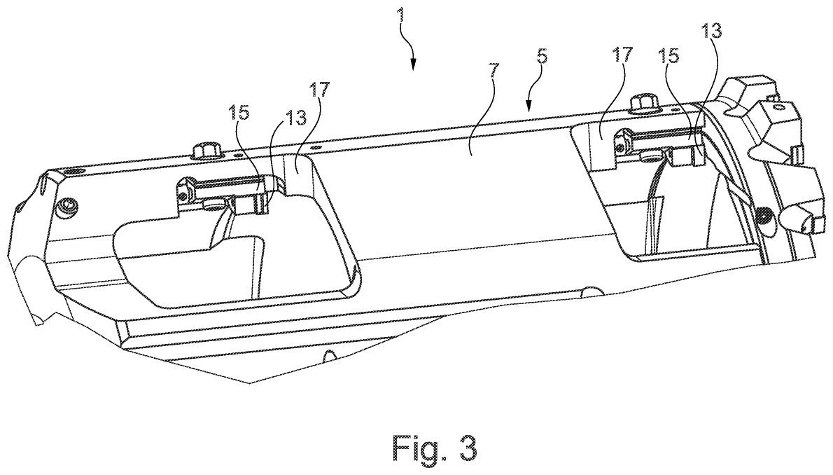

FIG. 3 a detailed illustration of the first embodiment of the tool according to FIGS. 1 and 2, and

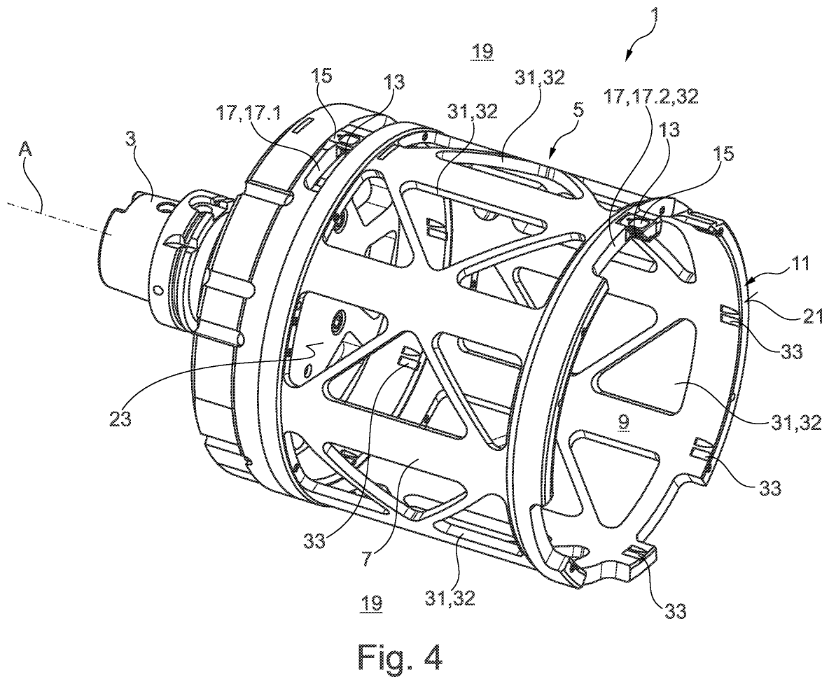

FIG. 4 an illustration of a second embodiment of a tool.

FIG. 1 shows a first illustration of a first embodiment of a tool 1 for machining an outer circumferential surface of a workpiece not shown. The tool 1 comprises an interface 3 which is adapted to attach the tool 1 to a counter interface, in particular a counter interface of a machine spindle, in particular of a machining centre. The tool 1 also has a base body 5 which is cylindrical, preferably circular-cylindrical, in particular tubular, at least in sections. The base body 5 has a circumferential wall 7, which surrounds a mounting space 9—in the circumferential direction—and is configured to be open in the area of a frontal face 11. In this way, the workpiece can be at least partially inserted into the mounting space 9 via the open front face 11 and held in the mounting space 9.

A longitudinal or axial direction of the tool 1 extends along a longitudinal or rotational axis A of the tool 1. A radial direction is perpendicular to the longitudinal axis A, and a circumferential direction surrounds the longitudinal axis A concentrically.

At least one cutting edge 13 that engages in the mounting space 9 is arranged on the base body 5 and is adapted to machine the outer circumferential surface of the workpiece. In particular, a plurality of cutting edges 13 is arranged on the base body 5. The cutting edges 13 can be configured integrally with the circumferential wall 7. In the embodiment shown here, however, the cutting edges 13, which are preferably configured as cutting plates, are preferably configured in multipart form with the circumferential wall 7 and attached to it. A material-fit fastening, but also a form-fit and/or friction-fit fastening is possible. Preferably, the cutting edges 13 are arranged adjustable on the circumferential wall 7. In the embodiment shown here, the cutting edges 13 are held in cutting edge cassettes 15, in particular screwed to the cutting edge cassettes 15, wherein the cutting edge cassettes 15 are in turn screwed to the circumferential wall 7.

The circumferential wall 7 also has at least one chip passing recess 17, which is arranged relative to the at least one cutting edge 13 in such a way that chips removed by the at least one cutting edge 13 during machining of the workpiece can exit through the at least one chip passing recess 17 from the mounting space 9—radially—into an outer surrounding area 19 of the base body 5. In particular, the embodiment of the workpiece 1 shown here comprises a plurality of such chip passing recesses 17, wherein in particular each cutting edge 15 is associated with a chip passing recess 17.

The tool 1 is configured to be both light and stable and enables high-quality machining of workpieces, in particular with large external diameters and large projection lengths, in particular on a machining centre.

The chip passing recesses 17 are preferably each configured to be closed along a closed recess circumferential line, so that they are framed in particular by material of the circumferential wall 7 and thus form quasi windows in the circumferential wall 7.

The at least one cutting edge 13 is preferably arranged on a flight circle with a diameter of at least 170 mm to at most 300 mm, preferably from at least 180 mm to at most 280 mm, preferably from at least 190 mm to at most 270 mm, preferably from at least 200 mm to at most 260 mm.

The mounting space 9 preferably has a length, from an end face 21 arranged on the frontal side 11 to a base face 23 opposite in the direction of the longitudinal axis A, which corresponds to the flight circle of the at least one cutting edge 13 multiplied by a factor of at least 0.8 to at most 3.5, preferably from at least 2 to at most 3, preferably from at least 1.5 to at most 2.5.

Preferably, the tool 1 comprises as the at least one cutting edge 13 at least one first cutting edge 13.1 and at least one second cutting edge 13.2, wherein the first cutting edge 13.1 is arranged offset relative to the second cutting edge 13.2 in the direction of the longitudinal axis A and at the same time in the radial direction. Thus, in particular, a first flight circle is assigned to the first cutting edge 13.1, which is different from a second flight circle assigned to the second cutting edge 13.2. In this way, stepped external machining of the workpiece is possible.

A cutting ring 27 comprising at least one end cutting edge 25 is preferably arranged on the frontal side 11, which is preferably configured in multipart with the base body 5 and is connected, in particular screwed, to the base body 5. In particular, the cutting ring 27 preferably comprises the end face 21. The end cutting edges 25 are preferably screwed to the cutting ring 27. The cutting ring 27 preferably has at least one chip removal groove 29, via which chips removed by the at least one end cutting edge 25 can be discharged to the outside, in particular radially and/or axially to the rear in the direction of the interface 3. Preferably, each end cutting edge 25 is assigned a chip removal groove 29.

FIG. 2 shows a second illustration of the first embodiment of the tool 1 according to FIG. 1.

Identical and functionally identical elements are provided with the same reference symbols in all figures, so that reference is made to the previous description in each case.

In the embodiment shown here, the interface 3 is configured as a hollow shank taper interface. In another embodiment, the interface 3 can also be configured as a steep taper interface, a Morse taper interface or in another suitable manner.

The interface 3 is preferably configured in multipart form with the base body 5 and is connected thereto—in particular in a form-fit, force-fit and/or material-fit manner. Preferably, the interface 3 is screwed to the base body 5, in particular to the base face 23.

Preferably, the base body 5 comprises a first material, wherein the interface 3 comprises a second material. Preferably, the first material comprises a lower density than the second material, wherein in particular the first material is a light metal, in particular aluminium or an aluminium alloy, and the second material is steel.

The cutting ring 27 preferably comprises a third material which has a higher density than the first material of the base body 5, wherein the third material is preferably steel.

FIG. 3 shows a detailed illustration of the first embodiment of the tool 1 according to FIGS. 1 and 2. The cutting edges 13 with their associated chip passing recesses 17 can be recognised particularly well in this representation.

FIG. 4 shows an illustration of a second embodiment of the tool 1. The circumferential wall 7 preferably has at least one additional recess 31, in this case a plurality of additional recesses 31, wherein only some of the additional recesses 31 are designated with the corresponding reference sign for the sake of a clearer representation. In the embodiment shown here, the additional recesses 31 extend through the circumferential wall 7, so that the mounting space 9 is open through the additional recesses 31 with respect to the outer surrounding area 19. In contrast to the chip passing recesses 17, no cutting edge 13 is assigned to the additional recesses 31. The chip passing recesses 17 and the additional recesses 31 are collectively referred to as recesses 32.

In another embodiment, it is possible that the additional recesses 31—in the radial direction—are configured to be closed at least one sided, in particular towards the mounting space 9. Alternatively, it is possible for the additional recesses 31 to be closed towards the outer surrounding area 19, or closed on both sides. An embodiment is also possible wherein at least one of the additional recesses 31 extends through the circumferential wall 7, wherein at least one other additional recess 31 of the additional recesses 31 is configured to be closed on at least one sided.

The recesses 32, i.e. the chip passing recesses 17 and the additional recesses 31, are preferably arranged in such a way that material of the circumferential wall 7 is not recessed in those areas in which load paths occur during machining of the workpiece. In this way, the tool 1 is configured in a quasi lattice-like manner and is both light and very stable.

At least one guiding bar 33 engaging in the mounting space 9 is preferably arranged on the base body 5. In the embodiment illustrated here, a plurality of guiding bars 33 is provided, wherein, for the sake of clarity, only some of the guiding bars 33 are labelled with the corresponding reference sign. By means of the guiding bars 33, the tool 1 is adapted in particular for finishing the workpiece.

The embodiment of the tool 1 shown here comprises in particular a first chip passing recess 17.1 and a second chip passing recess 17.2, which are designed differently from one another in particular in the following manner: While the first chip passing recess 17.1 is configured to be closed along a closed recess circumferential line, the second chip passing recess 17.2 is configured to be open at the frontal side. However, it is possible that a cutting ring is also arranged on the frontal side 11 in this configuration of the tool 1, which then also closes the second chip passing recess 17.2.

It is possible that the first embodiment of the tool 1 shown in FIG. 1 also comprises at least one additional recess 31 in a modification.

1. A tool for machining an outer circumferential surface of a workpiece, the tool comprising:
an interface which is adapted for fastening the tool to a counter interface, and with
a base body which is cylindrical at least in sections,
wherein
the base body has a circumferential wall encompassing a mounting space and is configured to be open at the frontal side in such a way that the workpiece can be at least partially accommodated in the mounting space,
wherein
at least one cutting edge engaging in the mounting space is arranged on the base body for the machining of the outer circumferential surface of the workpiece, and
wherein
the circumferential wall has at least one chip passing recess which is arranged relative to the at least one cutting edge in such a way that chips removed by the at least one cutting edge during the machining of the workpiece can exit through the at least one chip passing recess from the mounting space into an outer surrounding area of the base body.

2. The tool according to claim 1, wherein the tool comprises a plurality of cutting edges as the at least one cutting edge, wherein the circumferential wall comprises a plurality of chip passing recesses, and wherein at least one cutting edge of the plurality of cutting edges is assigned to each chip passing recess of the plurality of chip passing recesses in such a way that chips removed by the respectively assigned cutting edge can exit through the assigned chip passing recess from the mounting space into the outer surrounding area.

3. The tool according to claim 1, wherein the at least one chip passing recess is configured to be closed along a closed recess circumferential line.

4. The tool according to claim 1, wherein the circumferential wall comprises at least one additional recess 3.

5. The tool according to claim 1, wherein the at least one additional recess:
extends through the circumferential wall, or
is configured to be closed on at least one sided.

6. The tool according to claim 1, wherein the at least one cutting edge is arranged on a flight circle with a diameter of at least 170 mm to at most 300 mm, preferably from at least 180 mm to at most 280 mm, preferably from at least 190 mm to at most 270 mm, preferably from at least 200 mm to at most 260 mm.

7. The tool according to claim 1, wherein the mounting space has a length from an opening sided end face to an opposite base face which corresponds to the flight circle multiplied by a factor of at least 0.8 to at most 3.5, preferably from at least 2 to at most 3, preferably from at least 1.5 to at most 2.5.

8. The tool according to claim 1, wherein the tool comprises as the at least one cutting edge at least one first cutting edge and at least one second cutting edge-, wherein the at least one first cutting edge is orientated relative to the at least one second cutting edge is arranged offset in the axial direction of the base body, and wherein, in addition, the at least one first cutting edge is assigned a first flight circle which is different from a second flight circle assigned to the at least one second cutting edge.

9. The tool according to claim 1, wherein the base body and the interface are configured in multipart form and are connected to one another.

10. The tool according to claim 1, wherein the base body comprises a first material, wherein the interface comprises a second material, wherein preferably the first material having a lower density than the second material, wherein in particular the first material is a light metal, in particular aluminium or an aluminium alloy, and the second material is steel.

11. The tool according to claim 1, wherein a cutting ring comprising at least one end cutting edge is arranged on an opening sided end face of the base body-, which cutting ring is preferably configured in multipart form with the base body and is connected to the base body-, wherein preferably the cutting ring comprises a third material which has a higher density than the first material of the base body, and wherein further preferably the third material is steel.

12. The tool according to claim 1, wherein the at least one cutting edge is
configured integrally with the circumferential wall, or
material-fit connected to the circumferential wall, or
form-fit and/or friction-fit mounted to the circumferential wall, or
arranged adjustable on the circumferential wall-.

13. The tool according to claim 1, wherein at least one guiding bar engaging in the mounting space is arranged on the base body.

14. The tool according to claim 1, wherein the circumferential wall including the at least one chip passing recess comprises a plurality of recesses, wherein each recess of the plurality of recesses is selected from a group consisting of a chip passing recess and an additional recess, and wherein preferably the plurality of recesses is arranged such that material of the circumferential wall is not recessed in regions of load paths occurring during the machining of a workpiece.
